(19) United States
(12) Patent Application Publication
(10) Pub. No.: US 2010/0258660 A1
(43) Pub. Date: Oct. 14, 2010

(54) Method of Grinding a Mineral Containing Ore

(75) Inventor: Brian Kelsey Loveday, Durban (ZA)

Correspondence Address: CARSTENS & CAHOON, LLP, 13760 NOEL ROAD, SUITE 900, DALLAS, TX, 75240, US

(73) Assignee: UNIVERSITY OF KWAZULU-NATAL, Westville (ZA)

(21) Appl. No.: 12/746,909

(22) PCT Filed: Dec. 10, 2008
(86) PCT No.: PCT/IB08/55206

§ 371 Date: Jun. 8, 2010

(30) Foreign Application Priority Data
Dec. 14, 2007 (ZA) 2007/10901
Dec. 10, 2008 (IB) PCT/IB2008/055206

(51) Int. Cl. B02C 17/00

(52) U.S. Cl. 241/27

(57) ABSTRACT

A method of grinding a mineral-containing ore, which includes grinding the mineral-containing ore in a primary milling process and thereafter fine grinding the mineral-containing ore in a secondary ball-mill. A composite grinding medium comprising a mixture of steel balls and pebbles is used in the secondary ball-mill. The pebbles have an average size which is relatively smaller than the average size of the balls. The grinding medium includes an optimum mixture of approximately 25% pebbles and 75% steel balls by volume. The pebbles have a hardness which is substantially equivalent to or relatively harder than the hardness of the mineral-containing ore. The use of the composite grinding medium including the optimum mixture of steel balls and pebbles results in significant savings in energy consumption together with a reduction in ball consumption.

### FIELD OF INVENTION

This invention relates to a method of grinding a mineral-containing ore.

### BACKGROUND OF THE INVENTION

Grinding is an important and relatively expensive step in the processing of mineral-containing ore. The initial stage of size reduction is usually done in a crusher and/or a primary mill (typically a semi-autogenous grinding mill). A recent development is the use of a high-pressure grinding roll instead of a primary mill. The ore leaving the primary grinding device is normally processed in a secondary mill (ball-mill or pebble-mill), to produce a size distribution suitable for separation of the mineral by flotation, gravity separation, etc. Mills typically have a drum housing, the inner face of which defines a cylindrical grinding chamber. Steel balls are loaded into the grinding chamber together with the ore to be ground. The energy input to the ore is provided by the rotation of the mill about a horizontal axis so that steel balls in the mill are tumbled with or onto the ore in the mill.

It is well known that the size of the steel balls used in a ball-milling process should be tailored to suit the particle size of the ore. This is illustrated in FIG. 1 which was published by Austin, L. G., Klimpel, R. R. and Luckie, P. T., 1984, Ball wear and ball size selection, Process Engineering of Size Reduction: Ball Milling, AIME, New York, p 426.

The data in FIG. 1 was obtained in dry grinding experiments in a laboratory mill and it should be noted that the effect of ball size is significant (the scale is logarithmic). It is a reminder that significant improvements in the rate of grinding of particles less than 500 microns can be achieved by using a larger proportion of small grinding media. Steady-state addition of two ball sizes is common, but the use of small balls (less than 20 mm) is uncommon in most mineral processing operations, due to the increased cost of small balls and a less than proportional ball life.

The use of pebbles for grinding in place of steel balls is known in the art. For example, pebbles have been used for grinding ore in South African gold mines. In most cases, suitably sized lumps of ore are separated after crushing or removed from primary mills, via suitable ports. The size of the pebbles is typically in the size range 30 to 80 mm. The availability of pebbles in the correct size range must also be assured.

A primary mill often contains a mixture of pebbles and balls. For example the ore entering a semi-autogenous grinding (SAG) mill will typically have material ranging in size from fine sand to rocks up to 150 mm. The harder rocks will be worn away slowly and these pebbles play a significant roll in the mill. The balls usually constitute about a third of the volume of the charge in a SAG mill. Some applications have a higher proportion of balls. In many cases, pebble consumption limits throughput and pebble ports are used to extract pebbles for crushing. It should be noted that the primary mill is designed to maximise the rate of breakage of the larger particles. Hence these mills are operated at a ‘high’ speed (75 to 90 per cent of critical speed) which results in a cataracting motion in the mill and large steel balls (100 mm or 125 mm) are used.

In contrast, the ball mills used for secondary grinding are designed for maximising the efficiency of fine grinding. They are usually operated at about 68 per cent of critical speed, to reduce liner wear and hence there are less severe impacts in these mills. The feed may contain particles up to about 13 mm and there must be sufficient balls in the size range 30 mm to 45 mm to grind the coarser particles. However the ball size also determines the efficiency of grinding the smaller particles down to the finished product. Hence, it is common practice to add two ball sizes, where the smaller size provides improved efficiency for grinding smaller particles (1 mm to 200 microns). These balls are more expensive and ball consumption is higher.

It is also known in the art for secondary mills to contain pebbles, which are relatively large (say 30 mm to 60 mm). These pebbles are sometimes withdrawn from the primary mill, and used in the secondary mill in place of balls (to reduce operating costs). The grinding efficiency of these pebbles would however be less than that of (smaller) balls.

The use of pebbles only in both primary and secondary mills is also known. In view of the lower density of a charge of pebbles only as the grinding media, significantly larger secondary grinding mills would be needed, (e.g. for drums of the same length, the drum diameters would need to be about 32% larger), but the same shaft power would apply. Alternatively, about twice as many mills of the same size would be required, with smaller motors. A limited pebble storage facility would also be needed. Secondary grinding with pebbles could be an attractive option for older mines, where tonnage is being scaled down, spare mills are available and savings in operating costs are important. However, in view of the increased capital cost and some uncertainties about the supply of pebbles, conventional pebble-milling is not normally an attractive option for new plants.

It has been assumed for many years that fine grinding in a ball mill occurs as a result of attrition between balls and that fine grinding capacity is related to the surface area of the balls. However, one way of interpreting FIG. 1, is that larger particles require more force for breakage. Hence, there is a concern that small pebbles may not have the same momentum as steel balls of the same size, or that a pebble charge may not exert sufficient pressure on small rotating media.

Furthermore, pebbles wear away and must be replaced continually. Relatively large pebbles must be available for pebble milling applications and the processing plant may experience problems if the feed does not contain sufficient pebbles for significant periods of time. In view of the abovementioned problems with grinding using pebbles only, ball-milling is preferred in many cases, despite the ongoing cost of replacing steel balls.

It is the object of the present invention to overcome the abovementioned shortcomings associated with the use of pebbles and/or steel balls for milling mineral-containing ore.

### SUMMARY OF THE INVENTION

According to the invention there is provided a method of fine grinding a mineral containing ore, which includes grinding the ore in a ball-mill, using a composite grinding medium comprising a mixture of steel balls and pebbles.

The grinding medium may include pebbles which have an average size that is relatively smaller than the average size of the balls.

The grinding medium may include between 15% and 50% pebbles by volume and between 85% and 50% steel balls by volume.

The grinding medium may include approximately 25% pebbles and 75% steel balls by volume.

The steel balls of the grinding medium may have a size range of between 20 mm and 50 mm when the balls are introduced into the ball-mill.

The pebbles of the grinding medium may have a size range of between 6 mm and 25 mm when the pebbles are introduced into the ball-mill.

The pebbles may have an average size of approximately 15 mm.

The pebbles of the grinding medium may have a hardness which is substantially equivalent to the hardness of the mineral-containing ore.

The pebbles of the grinding medium may be relatively harder than the mineral containing ore.

The method may include grinding the mineral-containing ore in a primary milling process and thereafter further grinding the mineral-containing ore in a secondary milling process using the composite grinding medium.

The method may include transferring pebbles derived from the primary milling process to the secondary milling process to form part of the composite grinding medium used in the secondary milling process.

Alternatively, the method may include transferring pebbles from a crushing circuit to the secondary milling process to form part of the composite grinding medium used in the secondary milling process.

The invention extends to the grinding medium used in the method of fine grinding mineral-containing ore.

### BRIEF DESCRIPTION OF THE DRAWINGS

Further features of the invention are described hereinafter by way of non-limiting examples, with reference to and as illustrated in the accompanying diagrammatic drawings. In the drawings:

FIG. 1 depicts a graph illustrating the effect of ball size on the rate of breakage of particles in a dry laboratory-scale ball-mill;

FIG. 2 illustrates the preliminary laboratory-scale test data in a graph of energy per ton of fines for various proportions of steel balls and pebbles;

FIG. 3 depicts a graph of relative energy usage for fines production versus the relative mill volume required;

FIG. 4 depicts a graph which illustrates the size distributions of fine solids (having a size less than 3.3 mm), obtained by laboratory-scale tests on a copper containing ore; and

FIG. 5 depicts a bar chart showing the size distribution of the pebbles used in the pilot-scale ball-mill.

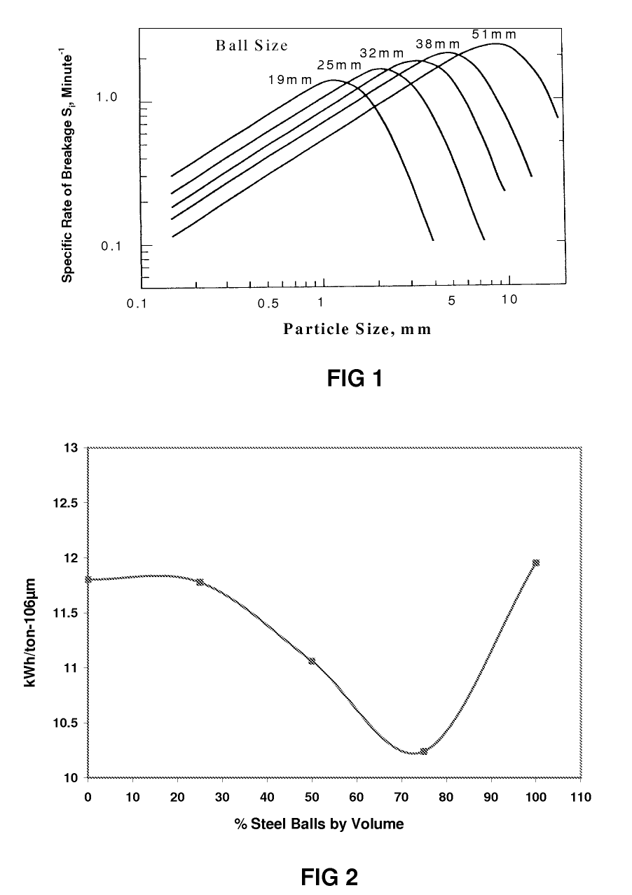

### DESCRIPTION OF PREFERRED EMBODIMENTS

Laboratory-scale and pilot-scale batch tests were conducted by the applicant to investigate the grinding efficiency of various mixtures of steel balls and pebbles in a ball-mill. The optimum proportions depend on ball size and pebble size but were found to be approximately 25% pebbles and 75% balls by volume.

Laboratory-Scale Tests

Preliminary laboratory-scale tests were carried out in a 300 mm diameter laboratory-scale ball-mill. The mill motor was freely suspended from a gearbox, to facilitate torque measurement and hence the measurement of mill power.

A charge of 29.3 kg of 40 mm steel balls was used as the base case. Various proportions of the ball load were replaced by an equal volume of crusher stone (quartz), with an average size of about 15 mm. The stone was a typical ‘small’ crusher stone for making concrete, with a size range of 7 to 25 mm and 60 per cent of the mass in the 13/19 mm size range. It is assumed that this material would be obtained from the primary grinding circuit and hence it would reduce the load in the primary circuit, and be available at no cost. The crusher stone was pre-rounded by tumbling in a pilot scale mill for a period, to remove the fine material which would be obtained initially from the pebbles.

The experiments were performed using a suspension of river sand and water (60 per cent sand by mass). A relatively low solids concentration was used to avoid viscosity effects. The mass of sand was 2.75 kg, it had an 80 per cent passing size of 1.2 mm, with only 0.8 was less than 106 microns. The changes in ball/pebble grinding mixture resulted in mill power varying between 27 to 95 W and hence the time of the experiment was adjusted to maintain an energy input of about 17 kWh/t of sand. The product size varied between 70 to 99 per cent passing 106 microns, depending upon the charge.

A summary of the laboratory-scale test results is set out in Table 1. The milling times were adjusted during the experiment, to maintain a constant energy per ton (i.e. the times were inversely related to mill power). As expected, mill power was reduced as steel was progressively replaced by lower density pebbles, which had a density of about 2700 kg/m^{3.}

Production of fines (with a size of less than 106 micron) was calculated by subtracting the small mass fines in the feed. Table 1 also shows the overall efficiency of power utilization for production of fines. The ball/pebble mixture showed significant promise when the grinding mixture was 75% steel balls by volume. It should be noted that the wear of the pebbles made a significant contribution to the production of fines, resulting in a comparable rate of production of fines.

TABLE 1
Summary of laboratory power data for
various mill charge configurations

| Volume of Steel | Power | Energy Usage | Pebble Mass |
|---|---|---|---|
| Balls (%) | (W) | (kWh/t-106) | Loss (%) |
| 100 | 95.38 | 11.95 | 0 |
| 75 | 82.51 | 10.24 | 8.27 |
| 50 | 60.54 | 11.06 | 2.05 |
| 25 | 52.47 | 11.78 | 1.75 |
| 0 | 26.92 | 11.80 | 1.09 |

With reference to FIG. 2, it can be seen that the energy per ton of fines drops significantly when the grinding mixture includes 75% steel balls by volume. The use of low density media normally comes at a price, as the mill volume must be increased to obtain a comparable power draw. The mill volume, relative to the base case of 40 mm steel balls, was calculated for equivalent production of fines as follows:

$$\begin{matrix}R \cdot Energy = \frac{{( kWh \text{/} t - 106 μm )}_{Mixed . load}}{{( kWh \text{/} t - 106 μm )}_{Base . case}} \cdot 100 & ( 1 ) \\ R \cdot Volume = \frac{{Power}_{Base . case}}{{Power}_{Mixed . load}} \cdot \frac{{( kWh \text{/} t - 106 μm )}_{Mixed . load}}{{( kWh \text{/} t - 106 μm )}_{Base . case}} \cdot 100 & ( 2 )\end{matrix}$$

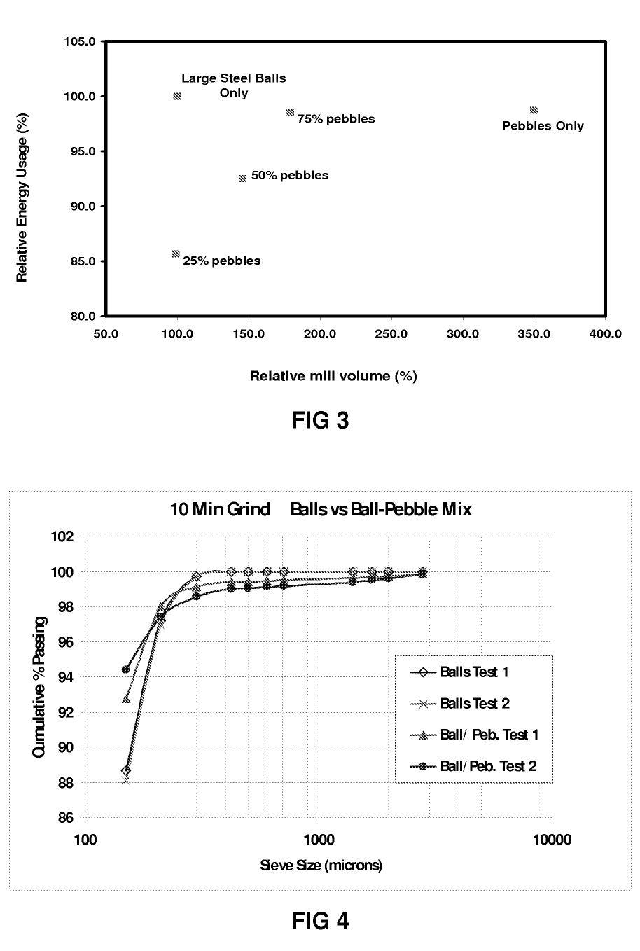

With reference to FIG. 3 the relative energy usage of the various proportions of pebbles/balls is expressed in terms of relative mill volume.

FIG. 3 highlights the importance of using a portion of small pebbles, mixed with steel balls. In practice the mill would contain the natural distribution of ball sizes, which results from steady-state addition of the top size. This is approximately equivalent to equal numbers of all sizes on a linear progression. Hence, some small steel balls are present, but FIG. 3 shows that the presence of small pebbles provides a significant saving in power consumption.

The use of a charge containing 25 per cent pebbles appears to be particularly attractive, as the mill volume does not need to be increased, the energy consumption is reduced by 13 per cent and ball consumption is reduced by 25 per cent. A reduction in ball consumption follows from the fact that ball wear is expected to be about the same, but in view of the fact that the volume of balls has been reduced to 75 per cent of the base case, the rate of ball make-up will be reduced accordingly. An examination of the data for this experiment showed that 312 g was transferred from pebbles to pulp, (using a minimum pebble size of 5.4 mm). This is equivalent to a loss of 8 per cent of the pebbles and an addition of 11 per cent to the sand mass.

Further laboratory-scale tests were conducted at the optimum conditions, using amples of copper containing ore, which were obtained from an operating plant. A sample of the feed to existing secondary ball-mills was used and pebbles were removed from crushed ore by screening. These tests were more sophisticated, in that the ball charge had a range of sizes which simulated steady-state addition of 40 mm balls to a charge containing balls having a distribution of sizes, due to ongoing wear. Several locked-cycle tests were performed to determine the steady-state consumption of pebbles. The mill content was removed after each test and washed through a 3.3 mm screen. The balls were then separated manually and the screen oversize was weighed. ‘Fresh’, (un-rounded) pebbles in the size range 13 to 22 mm, were added to top up the mass of pebbles. The test was repeated until the pebble consumption was constant. The size distribution of the product (passing 3.3 mm) was then compared to that obtained using steel balls alone. In view of the previous laboratory data, the grinding time was left the same as that of the ball-milling base case. This simulates the addition of pebbles to the existing ball-mills, (after allowing the ball charge to wear down to a reduced volume). The smaller average size of the pebbles relative to that of the balls increases the rate of grinding of small particles, thereby providing improved grinding efficiency. The throughput is increased by the addition of pebbles, the power is reduced and the ball consumption is reduced in proportion to the volume fraction replaced by pebbles. Several tests were done, to determine the sensitivity to variations in ore hardness.

Table 2 shows a summary of average results obtained when a 75/25 mixture of balls and pebbles were used (The pebble size range was 13 to 22 mm).

TABLE 2
Summary for 75/25 mixture, using pebbles
in the size range 13 to 22 mm

| | | | Pebble Consumption | |
|---|---|---|---|---|
| Grind | % passing 150 microns | | (% rel. to ‘sand’ | Power |
| Time (min.) | Balls | Ball/Pebble | in mill) | Saving (%) |
| 5 | 77 | 79 | 3 | 8.3 |
| 10 | 88 | 94 | 6 | 9.1 |

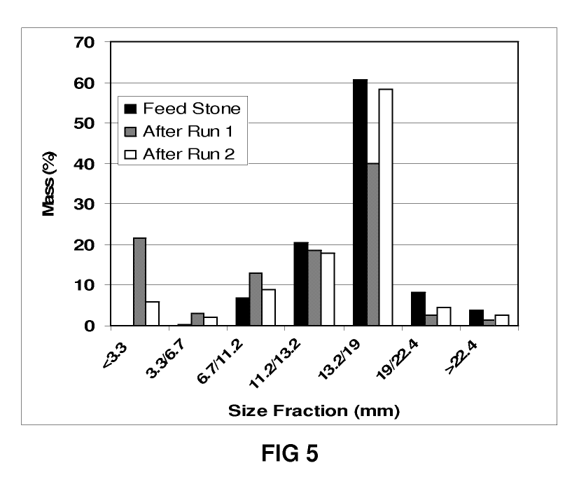

FIG. 4 shows the size distributions produced in the 10 minute tests. A small amount of tramp oversize was produced by the pebbles, but this should be taken care of in a closed circuit milling system. It is also possible to recycle this material to the primary milling circuit, by diverting a cyclone underflow.

A few additional (10 minute) tests were performed on the copper ore, using pebbles with larger upper size limit (about 27 mm), in view of the current plant screening practice. The larger pebbles would be less efficient, but last longer, resulting in lower pebble consumption. The use of a larger proportion of pebbles in the mill charge (37.5%) was tested simultaneously. The results were as follows:

| | |
|---|---|
| Reduction in power: | 13.6% |
| Reduction in ball consumption: | 37.5% |
| Product size: | 88% passing 150 microns |
| | (The same as ball-milling) |

Pilot-Scale Batch Tests

Having determined an optimum proportion of small pebbles in the laboratory scale ball-mill, a few tests were performed in a 1.2 m diameter batch ball-mill, to see how the small pebbles performed in an environment with larger impact forces. The pilot-scale ball-mill was fitted with 40 mm lifter bars and it was operated at 68 per cent of critical speed. The ball charge simulated a steady-state addition of 35 mm steel balls, with equal numbers of 35, 27 and 15 mm balls and a total mass of 294 kg. The availability of the 35 mm balls determined the above, giving a superficial charge volume of only 22 per cent. Tests at this relatively low charge level simulated impact conditions in a larger mill and hence the use of a low charge volume is not regarded as a negative feature. The ‘small’ crusher stone used in the initial laboratory tests was used for experiments with a mixed charge. The stones were re-used, resulting in a gradual shift in the average size of the stone. The charge of river sand was 29 kg. The slurry did not fill the voids in the static charge completely, simulating conditions in a grate discharge mill. The mill was fitted with a torque monitoring device and a net mill power of 2.1 to 2.4 kW was observed. The experiments were conducted over a 10 minute period, which is equivalent to about 15 kWh/t of sand. The experiments were labour intensive, with manual loading and unloading of the mill charge. After each experiment, the milled sand was flushed from the mill and allowed to settle in containers, for removal of excess water. A riffle splitter was then used to split the slurry into progressively smaller portions, yielding two duplicate sample masses containing about 900 g of sand after five splits. Wet and dry screening was then used for size analysis.

FIG. 5 shows that relatively rapid wear and breakage of the pebbles occurred when they were used for the first time, with 22 per cent appearing in the fractions finer than 3.3 mm. The production of fines from pebbles was reduced significantly in the second run, as expected, having eliminated the sharp corners and fractured material. The rate of wear of the pebbles in the second run would be more indicative of the wear of pebbles down to the size at which they were removed by pulp flow and transported out of the mill.

An analysis of the fines produced by the mill showed that the rate of production of (−106 micron) fines, using the 75/25 mixed charge, was about the same as that produced by balls. An average power saving of 13.5% was observed.

The Applicant believes that existing full-scale ball-mills can be used for grinding using the composite ball/pebble grinding medium and that the conversion will carry very little risk. No additional mill volume will be required, as is required with conventional pebble milling. Pebbles in the appropriate size rage can be introduced slowly, to build up the load of pebbles in the mill without affecting throughput or product size. The deflection of pebbles from the primary circuit can be implemented relatively cheaply by the introduction of suitable screens. Older plants, with conventional crushing, also provide a convenient source of small pebbles.

The saving in energy consumption occurs as a result of the reduction in power drawn by the mill with a composite load. The reduction in ball consumption is based on the assumption that the rate of ball wear will remain the same and hence ball addition is linked to the steady-state hold-up of balls in the mill.

The Applicant envisages that a practical implementation of the milling process could be as follows:
a. The primary (SAG) mill will have pebble ports and discharge onto a screen or trommel, for removal of coarse material. A 25 mm screen can be used to remove the larger rocks for crushing, with on/off control, to maintain level in the primary mill.
b. A second screen deck (about 10 mm) will be used to separate the 10/25 mm pebbles, for use in the ball-mill. As the pebbles wear away, they will reach the size at which they will be broken by the balls. Hence, the lower size limit for the feed pebbles will depend upon the size of balls in the mill.
c. Alternatively, a secondary crusher could be installed ahead of the primary mill, which could crush a portion of the feed to the primary mill to pass 25 mm, thereby providing a source of small pebbles.
d. Some underflows from cyclones in the secondary milling circuit could be diverted to the primary mill, to ensure that the addition of pebbles to the ball mills does not result in an accumulation of a coarse fraction in the secondary circuit.
e. Ball and pebble addition to the secondary composite charge mill(s) will have to be controlled to maintain the charge level in the mill(s). The control system could be based on sound at the ‘toe’ of the mill charge and/or mill mass. The proportion of pebbles will depend upon the size distribution of the product. If, for example, the feed is relatively fine, a larger proportion of small pebbles can be used.

The use of a composite pebble/ball grinding medium in a secondary mill for fine grinding mineral-containing ore thus ameliorates the abovementioned problems experienced with the use of balls or pebbles separately in secondary mills. At an optimum mixture of about 75% balls:25% pebbles by volume, significant savings in energy consumption can be achieved together with a reduction in ball consumption. The optimum volume of pebbles will be determined by economic considerations, as there may be a trade-off between savings in ball consumption and savings in power consumption.

1. A method of fine grinding mineral-containing ore, which includes grinding the ore in a ball-mill, using a composite grinding medium comprising a mixture of steel balls and pebbles.

2. The method as claimed in claim 1, wherein the grinding medium includes pebbles which have an average size that is relatively smaller than the average size of the balls.

3. The method as claimed in claim 1 or claim 2, wherein the grinding medium includes between 15% and 50% pebbles by volume and between 85% and 50% steel balls by volume.

4. The method as claimed in any one of claims 1 to 3, wherein the grinding medium includes approximately 25% pebbles and 75% steel balls by volume.

5. The method as claimed in any one of claims 1 to 4, wherein the steel balls of the grinding medium have a size range of between 20 mm and 50 mm when the balls are introduced into the ball-mill.

6. The method as claimed in any one of claims 1 to 5, wherein the pebbles of the grinding medium have a size range of between 6 mm and 25 mm when the pebbles are introduced into the ball-mill.

7. The method as claimed in claim 6, wherein the pebbles have an average size of approximately 15 mm.

8. The method as claimed in any one of claims 1 to 7, wherein the pebbles of the grinding medium have a hardness which is substantially equivalent to the hardness of the mineral-containing ore.

9. The method as claimed in any one of claims 1 to 7, wherein the pebbles of the grinding medium are relatively harder than the mineral-containing ore.

10. The method as claimed in any one of claims 1 to 9, which includes grinding the mineral-containing ore in a primary milling process and thereafter further grinding the mineral-containing ore in a secondary milling process using the composite grinding medium.

11. The method as claimed in claim 10, which includes transferring pebbles derived from the primary milling process to the secondary milling process to form part of the composite grinding medium used in the secondary milling process.

12. The method as claimed in claim 10, which includes transferring pebbles from a crushing circuit to the secondary milling process to form part of the composite grinding medium used in the secondary milling process.

13. The grinding medium used in the method of fine grinding mineral-containing ore as claimed in any one of claims 1 to 12.
